(19) United States
(12) Patent Application Publication
(10) Pub. No.: US 2025/0162139 A1
(43) Pub. Date: May 22, 2025

(54) DYNAMIC ROBOT ACTUATOR

(71) Applicant: APPTRONIK, INC., Austin, TX (US)

(72) Inventors: Bradley Aaron RESH, Austin, TX (US); Jonas Alexan FOX, Austin, TX (US); Paul Gloninger FLEURY, Austin, TX (US); Nicholas Arden PAINE, Austin, TX (US)

(21) Appl. No.: 18/839,334

(22) PCT Filed: Feb. 21, 2023
(86) PCT No.: PCT/US2023/062955

§ 371 Date: Aug. 16, 2024

Related U.S. Application Data
(60) Provisional application No. 63/311,872, filed on Feb. 18, 2022.

(51) Int. Cl. B25J 9/12; B25J 19/02; H02K 7/116; H02K 11/215; H02K 21/14

(52) U.S. Cl. CPC B25J 9/12; B25J 19/02; H02K 7/116; H02K 11/215; H02K 21/14

(57) ABSTRACT

A robotic actuator includes a mechanical ground, a motor coupled to the mechanical ground, a gearbox, and an actuator output coupled to an output of the gearbox. The gearbox includes a first plurality of planetary gears, a sun gear coupled to the motor and configured to transmit torque produced by the motor to the first plurality of planetary gears, a second plurality of planetary gears coaxially coupled to the first plurality of planetary gears, and a ring gear coupled to the second plurality of planetary gears. Each planetary gear of the first plurality of planetary gears has a larger diameter than each planetary gear of the second plurality of planetary gears.

### TECHNICAL FIELD

The present disclosure describes robotic systems, such as upper-body humanoid robots.

### BACKGROUND

Robots use actuators to move around. Electric actuators are typically composed of an electric motor to convert electrical energy into high-speed, low-torque energy, and a gearbox to convert high-speed, low-torque energy into high-torque, low-speed energy.

Industrial robots for years have used highly precise gearboxes with large speed reductions in the 50:1 to 150:1 range. Actuators with large gear ratios excel at magnifying the torque of an electric motor, but suffer from large reflected inertia. Large reflected inertia makes these robots fragile, power hungry, and unsafe to use in unstructured environments.

Recently there has been a proliferation of development in quadrupedal robots, such as Boston Dynamics Spot robot, the MIT Mini Cheetah, and others. Many of these robots use an actuation approach called Quasi Direct Drive (QDD) which uses a motor with a large air gap radius (large diameter) coupled to a low ratio gearbox (typically in the 10:1 range) to achieve an actuator with low reflected inertia yet high torque. These actuators also benefit from having low friction and high efficiency. The 10:1 gear ratio is typically achieved using a single stage planetary gearbox, which is approaching the limit of what's possible with a single stage planetary gearbox architecture.

### SUMMARY

In an example implementation, a robotic actuator includes a mechanical ground, a motor coupled to the mechanical ground, a gearbox, and an actuator output coupled to an output of the gearbox. The gearbox includes a first plurality of planetary gears, a sun gear coupled to the motor and configured to transmit torque produced by the motor to the first plurality of planetary gears, a second plurality of planetary gears coaxially coupled to the first plurality of planetary gears, and a ring gear coupled to the second plurality of planetary gears. Each planetary gear of the first plurality of planetary gears has a larger diameter than each planetary gear of the second plurality of planetary gears.

In an aspect combinable with the example implementation, the gearbox has a gear ratio between 10:1 and 25:1.

In another aspect combinable with any of the previous aspects, a ratio of a power of the motor to a radial dimension of the robotic actuator is between 1 RMS Watts/mm to 20 RMS Watts/mm.

In another aspect combinable with any of the previous aspects, the radial dimension corresponds to a radius of a front surface of the mechanical ground.

In another aspect combinable with any of the previous aspects, a power rating of the motor is between 100 RMS Watts and 1000 RMS Watts.

In another aspect combinable with any of the previous aspects, the robotic actuator is configured to generate an amount of torque between 20 RMS Nm and 200 RMS Nm.

In another aspect combinable with any of the previous aspects, a backlash between the mechanical ground and the actuator output is between 6 arcminute and 50 arcminute.

In another aspect combinable with any of the previous aspects, the robotic actuator is configured to generate a reflected inertia is between 0.01 kg·m² and 1.00 kg·m².

In another aspect combinable with any of the previous aspects, a ratio of an axial dimension of the robotic actuator to a radial dimension of the robotic actuator is between 0.1 and 5.0.

In another aspect combinable with any of the previous aspects, the axial dimension corresponds to a distance between a rear surface of the mechanical ground and a front surface of the actuator output.

In another aspect combinable with any of the previous aspects, at least one of the motor or the gearbox is circumferentially surrounded by the mechanical ground.

Another aspect combinable with any of the previous aspects further includes a planet carrier coupled to the mechanical ground and configured to support the first plurality of planetary gears and the second plurality of planetary gears.

In another aspect combinable with any of the previous aspects, the planet carrier is coupled to the mechanical ground by at least one bearing.

In another aspect combinable with any of the previous aspects, the motor, gearbox and planet carrier are circumferentially surrounded by the mechanical ground.

In another aspect combinable with any of the previous aspects, wherein the motor includes a stator coupled to the mechanical ground and configured to generate a magnetic field, and a rotor configured to generate the torque based on interaction between the rotor and the magnetic field.

Another aspect combinable with any of the previous aspects further includes a sensor configured to detect commutation of the motor.

In another aspect combinable with any of the previous aspects, the sensor is an incremental rotary encoder.

In another aspect combinable with any of the previous aspects, the sensor includes a ring magnet mounted to the motor, and a read head coupled to the mechanical ground and configured to detect a magnetic field generated by the ring magnet.

Another aspect combinable with any of the previous aspect further includes a sensor configured to detect an amount of output of the robotic actuator.

In another aspect combinable with any of the previous aspects, the sensor includes a magnet coupled to a distal end of a shaft, wherein a proximal end of the shaft is coupled to the actuator output, and a read head coupled to the mechanical ground and configured to detect a magnetic field generated by the magnet.

In another aspect combinable with any of the previous aspects, the read head generates a signal indicating angular displacement of the magnet relative to the mechanical ground.

In another example implementation, a humanoid robot includes at least one robotic limb, and an actuator configured to move at least a portion of the at least one robotic limb. The actuator includes a stepped planet compound planetary gearbox.

In an aspect combinable with the example implementation, the at least one robotic limb is a robotic leg.

In another aspect combinable with any of the previous aspects, the humanoid robot is a hip joint assembly, and the actuator is configured to adjust the respective hip joint assembly in two degrees of hip freedom through differential linear actuation.

In another aspect combinable with any of the previous aspects, the actuator has a gear ratio between 10:1 and 25:1.

In another aspect combinable with any of the previous aspects, the actuator is configured to generate an amount of torque between 20 RMS Nm and 200 RMS Nm.

In another aspect combinable with any of the previous aspects, the actuator is configured to generate a reflected inertia is between 0.01 kg·m² and 1.00 kg·m².

In another aspect combinable with any of the previous aspects, a ratio of an axial dimension of the actuator to a radial dimension of the actuator is between 0.1 and 5.0.

In another aspect combinable with any of the previous aspects, the axial dimension corresponds to a distance between a rear surface of a mechanical ground of the actuator and a front surface of an output of the actuator.

In another aspect combinable with any of the previous aspects, the stepped planet compound planetary gearbox includes a first plurality of planetary gears, a sun gear coupled to a motor and configured to transmit torque produced by the motor to the first plurality of planetary gears, a second plurality of planetary gears coaxially coupled to the first plurality of planetary gears, and a ring gear coupled to the second plurality of planetary gears. Each planetary gear of the first plurality of planetary gears has a larger diameter than each planetary gear of the second plurality of planetary gears.

In another aspect combinable with any of the previous aspects, a backlash between the first plurality of planetary gears and the second plurality of planetary gears is between 6 arc minimum and 12 arc minimum.

Another aspect combinable with any of the previous aspect further includes a planet carrier configured to support the first plurality of planetary gears and the second plurality of planetary gears.

In another aspect combinable with any of the previous aspects, the actuator further includes a mechanical ground, a motor coupled to the mechanical ground, and an actuator output coupled to an output of the stepped planet compound planetary gearbox.

In another aspect combinable with any of the previous aspects, a ratio of a power of the motor to a radial dimension of the actuator is between 1 RMS Watts/mm to 20 RMS Watts/mm.

In another aspect combinable with any of the previous aspects, the radial dimension corresponds to a radius of a front surface of the mechanical ground.

In another aspect combinable with any of the previous aspects, a backlash between the mechanical ground and the actuator output is between 6 arcminute and 50 arcminute.

In another aspect combinable with any of the previous aspects, a power rating of the motor is between 100 RMS Watts and 1000 RMS Watts.

In another aspect combinable with any of the previous aspects, at least one of the motor or the stepped planet compound planetary gearbox is circumferentially surrounded by the mechanical ground.

In another aspect combinable with any of the previous aspects, the motor includes a stator coupled to the mechanical ground and configured to generate a magnetic field, and a rotor configured to generate torque based on interaction between the rotor and the magnetic field.

Another aspect combinable with any of the previous aspect further includes a sensor configured to detect commutation of the motor.

In another aspect combinable with any of the previous aspects, the sensor comprises an incremental rotary encoder.

In another aspect combinable with any of the previous aspects, the sensor includes a ring magnet mounted to the motor, and a read head coupled to the mechanical ground and configured to detect a magnetic field generated by the ring magnet.

Another aspect combinable with any of the previous aspect further includes a sensor configured to detect an amount of output of the actuator.

In another aspect combinable with any of the previous aspects, the sensor includes a magnet coupled to a distal end of a shaft, wherein a proximal end of the shaft is coupled to the actuator output, and a read head coupled to the mechanical ground and configured to detect a magnetic field generated by the magnet.

In another aspect combinable with any of the previous aspects, the read head generates a signal indicating angular displacement of the magnet relative to the mechanical ground.

In another example aspect, a method of operating a humanoid robot includes operating an actuator; during operation, transmitting torque produced by the motor to the stepped planet compound planetary gearbox; and based on the torque transmitted to the stepped planet compound planetary gearbox, causing movement of at least a portion of a robotic limb coupled to the actuator output. The actuator includes a mechanical ground, a motor coupled to the mechanical ground, a stepped planet compound planetary gearbox, and an actuator output coupled to an output of the stepped planet compound planetary gearbox.

In an aspect combinable with the example implementation, the robotic limb is a robotic leg.

In another aspect combinable with any of the previous aspects, causing movement of the robotic limb coupled to the actuator output includes controlling adjusting a hip joint assembly in two degrees of hip freedom through differential linear actuation.

In another aspect combinable with any of the previous aspects, the stepped planet compound planetary gearbox has a gear ratio between 10:1 and 25:1.

In another aspect combinable with any of the previous aspects, transmitting torque produced by the motor to the stepped planet compound planetary gearbox causes the actuator to generate an amount of torque between 20 RMS Nm and 200 RMS Nm.

In another aspect combinable with any of the previous aspects, at least one of the motor or the stepped planet compound planetary gearbox is circumferentially surrounded by the mechanical ground.

In another aspect combinable with any of the previous aspects, the stepped planet compound planetary gearbox includes a first plurality of planetary gears, a sun gear coupled to the motor and configured to transmit torque produced by the motor to the first plurality of planetary gears, a second plurality of planetary gears coaxially coupled to the first plurality of planetary gears, and a ring gear coupled to the second plurality of planetary gears. Each planetary gear of the first plurality of planetary gears has a larger diameter than each planetary gear of the second plurality of planetary gears

Another aspect combinable with any of the previous aspect further includes a planet carrier configured to support the first plurality of planetary gears and the second plurality of planetary gears.

Another aspect combinable with any of the previous aspect further includes measuring an amount of output of the actuator using a sensor, the sensor including a magnet coupled to a distal end of a shaft, wherein a proximal end of the shaft is coupled to the actuator output, and a read head coupled to the mechanical ground and configured to detect a magnetic field generated by the magnet.

In another aspect combinable with any of the previous aspects, measuring the amount of output of the actuator includes receiving, from the read head, a signal indicating angular displacement of the magnet relative to the mechanical ground.

Another aspect combinable with any of the previous aspect further includes detecting commutation of the motor using a sensor, the sensor including a ring magnet mounted to the motor, and read head coupled to the mechanical ground and configured to detect a magnetic field generated by the ring magnet.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagrammatic representation of one embodiment of an actuator.

FIG. 2 is a diagrammatic representation of one embodiment of an actuator illustrating a cross-section of the actuator of FIG. 1.

FIG. 3 is a diagrammatic representation of one embodiment of the actuator of FIG. 1 with components removed to illustrate one embodiment of a set of gears in the gearbox subassembly.

FIG. 4 is a diagrammatic representation of one embodiment of a gearbox subassembly.

FIG. 5 is a diagrammatic representation of one embodiment of a gearbox subassembly illustrating a second view of the gearbox subassembly of FIG. 4.

FIG. 6 is a diagrammatic representation of one embodiment of a gearbox subassembly illustrating an exploded view of the gearbox subassembly of FIG. 4.

FIG. 7 is a diagrammatic representation of one embodiment of a motor subassembly and a gearbox subassembly.

FIG. 8 is a diagrammatic representation of a humanoid robot with the actuator of FIG. 1.

### DETAILED DESCRIPTION

The invention and the various features and advantageous details thereof are explained more fully with reference to the non-limiting embodiments that are illustrated in the accompanying drawings and detailed in the following description. Descriptions of well-known starting materials, processing techniques, components, and equipment are omitted so as not to unnecessarily obscure the invention in detail. It should be understood, however, that the detailed description and the specific examples, while indicating some embodiments of the invention, are given by way of illustration only and not by way of limitation. Various substitutions, modifications, additions, and/or rearrangements within the spirit and/or scope of the underlying inventive concept will become apparent to those skilled in the art from this disclosure.

In some cases, a gear ratio of more than 10:1 ratio is helpful, for example if higher torque output or less speed is required. A compound planetary can be used to obtain an additional reduction factor (up to ˜25:1 with a stepped planet compound planetary gearbox configuration (SPCPGT) while still retaining the benefits of a QDD (low inertia, low friction, etc.). Furthermore, embodiments described herein can be easier to manufacture than the high precision gearboxes used in industrial robotics, making them a more suitable option for many robotics applications. In addition, embodiments described herein provide a modular design.

Being able to increase gear ratio beyond what a single stage planetary configuration provides is beneficial for legged robotics applications. In legged locomotion, much of an actuator's torque goes towards inertial acceleration of the leg's own mass. In these situations, it is important to consider how power is transferred from the actuator to the leg inertia. It can be shown that matching the impedance of the leg to the impedance of the actuator's own inertia maximizes the power transfer between the actuator and the leg. Therefore, the SPCPGT configuration is useful to enable the gear ratio to be large enough to maximize power transfer while retaining benefits of QDD style actuation approaches specifically for legged robotics applications.

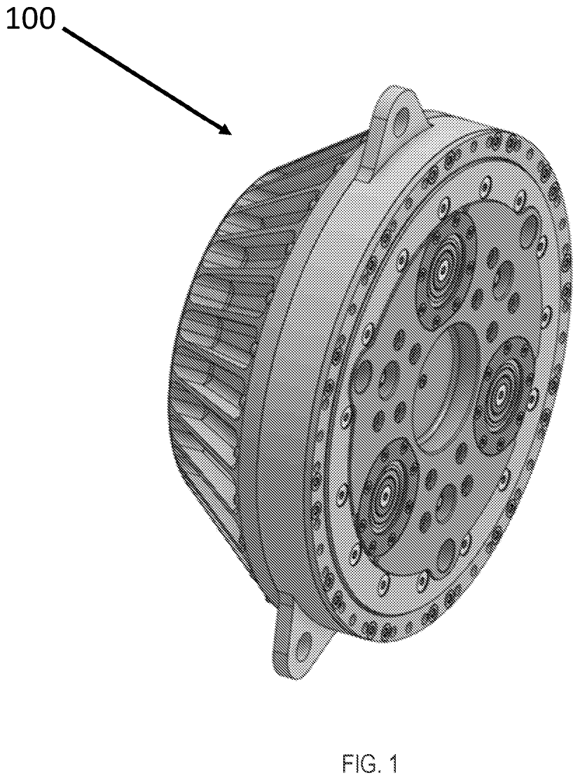

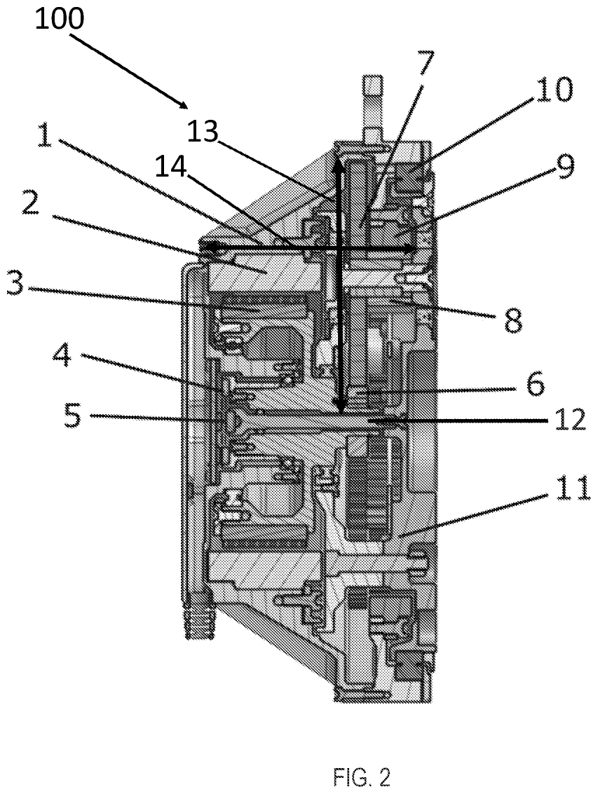

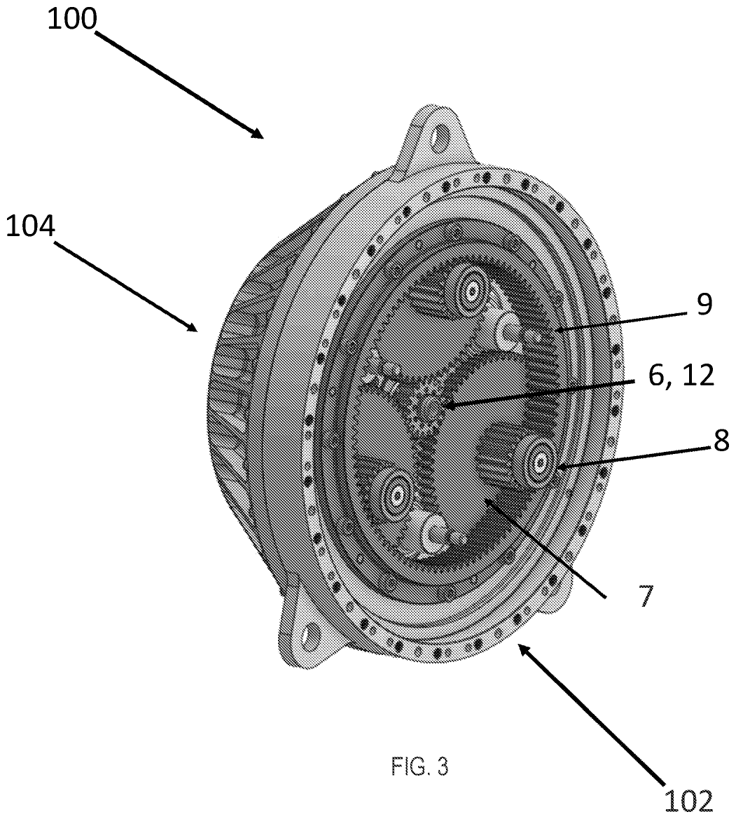

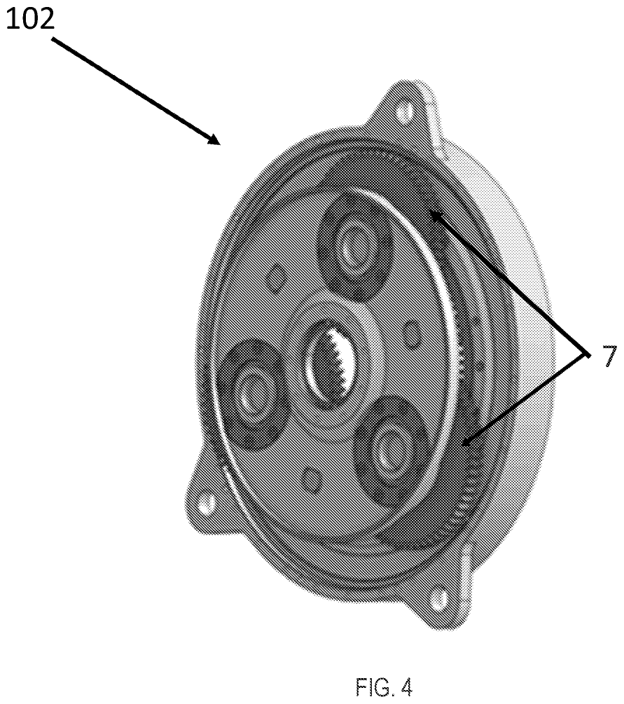

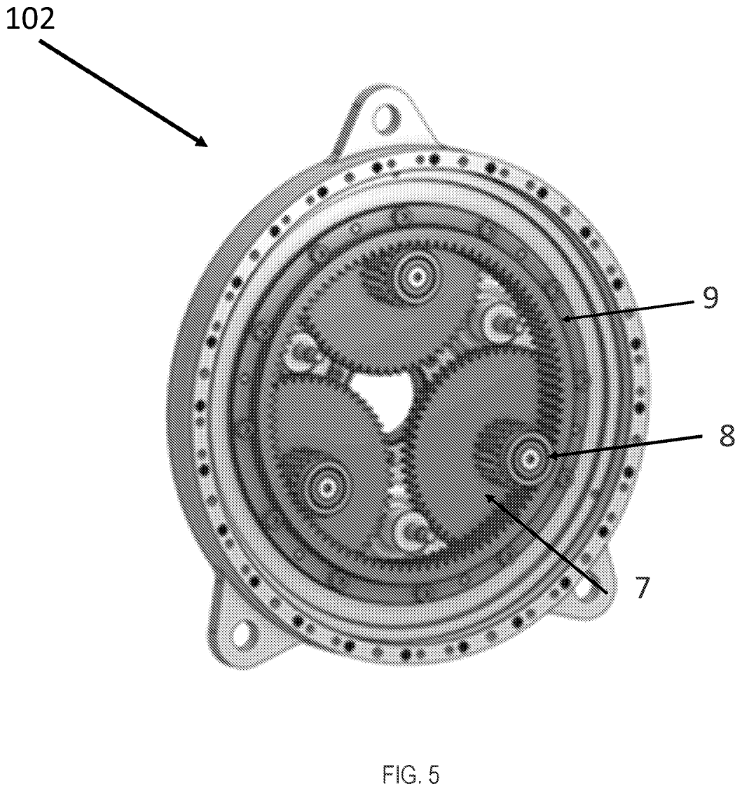

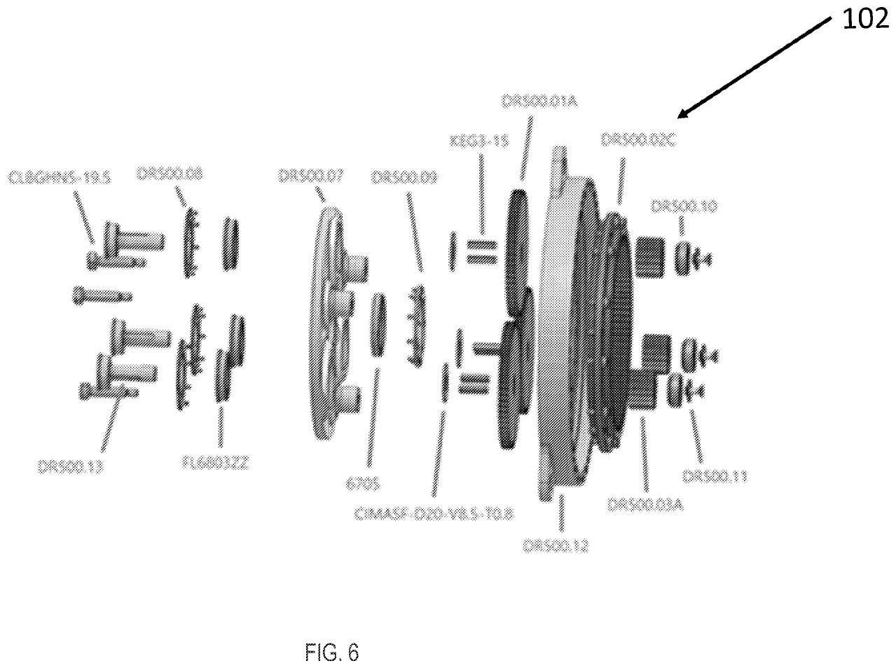

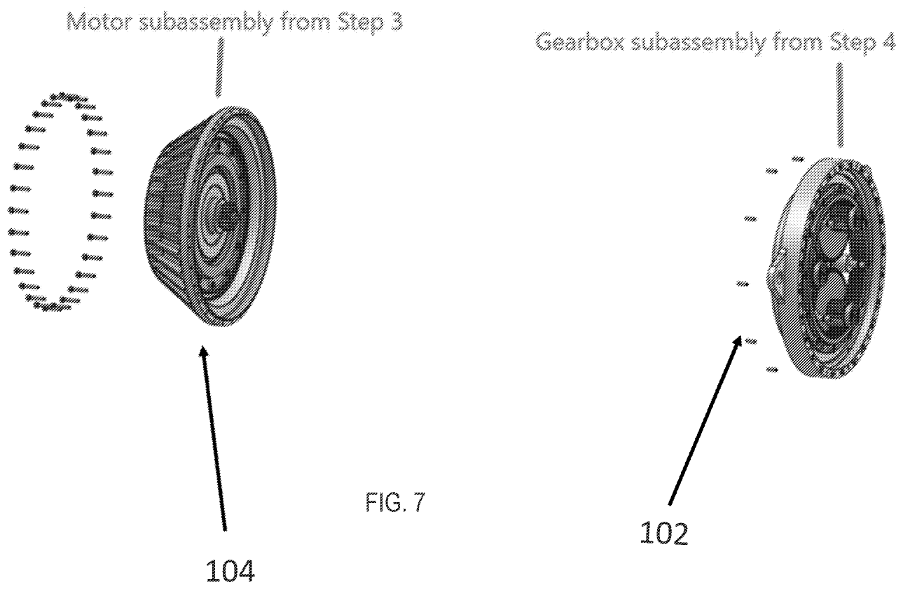

With reference to FIGS. 1-7, FIG. 1 is a diagrammatic representation of one embodiment of an actuator; FIG. 2 is a diagrammatic representation of one embodiment of an actuator illustrating a cross-section of the actuator of FIG. 1; FIG. 3 is a diagrammatic representation of one embodiment of the actuator of FIG. 1 with components removed to illustrate one embodiment of a set of gears in the gearbox subassembly; FIG. 4 is a diagrammatic representation of one embodiment of a gearbox subassembly; FIG. 5 is a diagrammatic representation of one embodiment of a gearbox subassembly illustrating a second view of the gearbox subassembly of FIG. 4; FIG. 6 is a diagrammatic representation of one embodiment of a gearbox subassembly illustrating an exploded view of the gearbox subassembly of FIG. 4 and FIG. 7 is a diagrammatic representation of one embodiment of a motor subassembly and a gearbox subassembly.

With reference to FIG. 2, the actuator 100 includes a mechanical ground 1 that serves as the modular mechanical mounting interface of the actuator 100. The actuator 100 is mechanically coupled to a motor 104 by the motor stator 2 that is affixed to the mechanical ground 1. The mechanical ground 1 provides both mechanical fixturing as well as a thermal pathway to ambient for the motor 104. A permanent magnet rotor 3 of the motor 104 produces torque due to interaction with the magnetic field produced by the motor's stator 2. In some implementations, the motor 104 coupled to the actuator 100 has a power rating ranging between 100 RMS Watts and 1000 RMS Watts.

In the illustrated embodiment, the actuator 100 includes two magnetic sensors, a motor commutation sensor 4 and an output position measurement sensor 5. A variety of sensor types may be used for the commutation sensor 4 and output position sensor 5. According to one embodiment, a magnetic incremental rotary encoder is used for the commutation sensor 4. A ring magnet is mounted to the rotor 3 or other portions of the motor 104 such that the ring magnet rotates with the rotor 3. The commutation sensor 4 can comprise a read head that is fixed relative to the mechanical ground 1. The read head of the commutation sensor 4 detects the magnetic field of the ring magnet of the commutation sensor 4. As will be appreciated, the read head of the commutation sensor 4 can output a signal indicative of the angular displacement of the ring magnet of the commutation sensor 4, which indicates the position of the rotor 3 relative to the mechanical ground 1.

According to one embodiment of an output position sensor 5, a magnet is coupled to and rotates with an output of the actuator 100. More particularly, in the embodiment illustrated, a center shaft 12 is fixed to the actuator output and the magnet of the output position sensor 5 is mounted at the end of the center shaft 12 distal from the actuator output. As the actuator output rotates, the center shaft 12 and, hence, magnet of the output position sensor 5 also rotates. A read head of the actuator output position sensor 5 is fixed relative to the mechanical ground 1 and positioned to detect the output of the magnetic field generated by the magnet of the output position sensor 5. The read head of the output position sensor 5 outputs a signal indicative of the angular displacement of the magnet of the output position sensor 5, and hence the angular displacement of the actuator output, relative to the mechanical ground 1.

The gearbox 102 of the actuator 100 includes a sun gear 6, a set of large planetary gears 7, a set of small planetary gears 8, and a ring gear 9. Torque produced by the motor 104 coupled to the actuator 100 is transmitted to the gearbox 102 of the actuator 100 using a sun gear 6. The sun gear 6 drives a set of large planetary gears 7. The large planetary gears 7 are coaxially fixed to a set of small planetary gears 8, which then interface with a ring gear 9. As a result, torque produced by the motor 104 results in rotation of the sun gear 6, the large planetary gears 7, the small planetary gears 8, and the ring gear 9. In some implementations, the actuator 100 is configured to generate an amount of torque ranging between 20 RMS Nm and 200 RMS Nm.

As depicted in FIG. 2, a planet carrier 11 is connected back to the mechanical ground 1 of the actuator 100 through a supporting bearing 10. The overall gear architecture is classified as a stepped planet compound planetary gearbox 102.

An actuator may be radially stacked in that one or more of the motor 104, the gearbox 102 or the actuator output are circumferentially contained within the actuator's mechanical ground 1. In the arrangement of FIG. 2, for example, the motor 104, gearbox 102, and planet carrier 11 are circumferentially within the mechanical ground 1 of the actuator 100.

As can be seen in FIGS. 3 and 5, the diameter of each of the large planetary gears 7 is larger than the diameter of each of the small planetary gears 8. In some implementations, the gearbox 102 has a gear ratio ranging between 10:1 and 25:1. In some implementations, the gearbox 102 of the actuator 100 includes three large planetary gears 7 and three small planetary gears 8. However, other numbers of large planetary gears 7 and small planetary gears 8 are possible.

In some implementations, a ratio of a power of the motor 104 mechanically coupled to the actuator 100 to a radial dimension 13 of the actuator 100 is between 1 root mean square (RMS) W/mm and 20 RMS W/mm. A ratio of the axial dimension 14 of the actuator 100 to the radial dimension 13 of the actuator 100 can range between 0.1 and 5.0. As depicted in FIG. 2, in some implementations, the radial dimension 13 of the actuator 100 corresponds to the radius of a front surface of the mechanical ground 1 and the axial dimension 14 of the actuator 100 corresponds to the distance between a rear surface of the mechanical ground 1 and a front surface of an output of the actuator 100.

In some implementations, the backlash between the mechanical ground 1 and an output of the actuator 100 is between 6 arcminute and 50 arcminute. In some implementations, the actuator 100 is configured to generate a reflected inertia between 0.01 kg·m² and 1.00 kg·m².

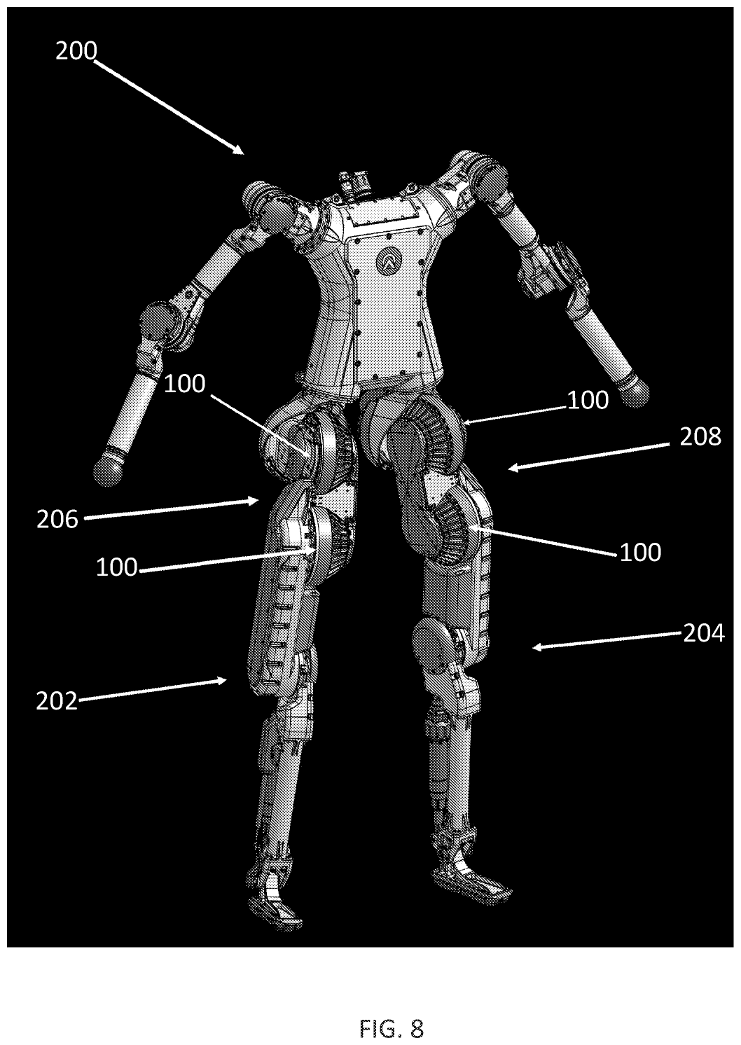

The actuator 100 can be coupled a robotic limb of a humanoid robot to control movement of the humanoid robot. For example, FIG. 8 depicts a humanoid robot 200 that includes a four actuators 100 each having a stepped planet compound planetary gearbox 102, as described herein. A first pair of actuators 100 are coupled to a first robotic leg 202 of the robot 200 and a second pair of actuators 100 are coupled to a second robotic leg 204 of the robot 200. The actuators 100 form a hip joint assembly 206, 208 for each leg 202, 204 of the robot 200 and are configured to adjust the respective hip joint assembly 206, 208 in two degrees of freedom through differential linear actuation of the actuators 100. The legs 202, 204 are mechanically coupled to the outputs of the respective actuators 100, and the torque generated by the motors 104 of the respective actuators 100 and transmitted to the gearboxes 102 of the respective actuators 100 cause movement of the respective robotic legs 202, 204.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only to those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when the antecedent basis is “a” or “an”) includes both singular and plural of such term, unless clearly indicated otherwise (i.e., that the reference “a” or “an” clearly indicates only the singular or only the plural). Also, as used in the description herein and throughout the meaning of “in” includes “in” and “on” unless the context clearly dictates otherwise.

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

Thus, while the invention has been described with respect to specific embodiments thereof, these embodiments are merely illustrative, and not restrictive of the invention. Rather, the description is intended to describe illustrative embodiments, features, and functions in order to provide a person of ordinary skill in the art context to understand the invention without limiting the invention to any particularly described embodiment, feature, or function, including any such embodiment, feature, or function described. While specific embodiments of, and examples for, the invention are described herein for illustrative purposes only, various equivalent modifications are possible within the spirit and scope of the invention, as those skilled in the relevant art will recognize and appreciate.

As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes, and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

1. A robotic actuator, comprising:
a mechanical ground;
a motor coupled to the mechanical ground;
a gearbox, comprising:
a first plurality of planetary gears;
a sun gear coupled to the motor and configured to transmit torque produced by the motor to the first plurality of planetary gears;
a second plurality of planetary gears coaxially coupled to the first plurality of planetary gears, each planetary gear of the first plurality of planetary gears has a larger diameter than each planetary gear of the second plurality of planetary gears; and
a ring gear coupled to the second plurality of planetary gears; and
an actuator output coupled to an output of the gearbox.

2. The robotic actuator of claim 1, wherein the gearbox has a gear ratio between 10:1 and 25:1.

3. The robotic actuator of claim 1, wherein a ratio of a power of the motor to a radial dimension of the robotic actuator is between 1 RMS Watts/mm and 20 RMS Watts/mm.

4. The robotic actuator of claim 3, wherein the radial dimension corresponds to a radius of a front surface of the mechanical ground.

5. The robotic actuator of claim 1, wherein a power rating of the motor is between 100 RMS Watts and 1000 RMS Watts.

6. The robotic actuator of claim 1, wherein the robotic actuator is configured to generate an amount of torque between 20 RMS Nm and 200 RMS Nm.

7. The robotic actuator of claim 1, wherein a backlash between the mechanical ground and the actuator output is between 6 arcminute and 50 arcminute.

8. The robotic actuator of claim 1, wherein the robotic actuator is configured to generate a reflected inertia is between 0.01 kg·m² and 1.00 kg·m².

9. The robotic actuator of claim 1, wherein a ratio of an axial dimension of the robotic actuator to a radial dimension of the robotic actuator is between 0.1 and 5.0.

10. The robotic actuator of claim 9, wherein the axial dimension corresponds to a distance between a rear surface of the mechanical ground and a front surface of the actuator output.

11. The robotic actuator of claim 1, wherein at least one of the motor or the gearbox is circumferentially surrounded by the mechanical ground.

12. The robotic actuator of claim 1, further comprising:
a planet carrier coupled to the mechanical ground and configured to support the first plurality of planetary gears and the second plurality of planetary gears.

13. The robotic actuator of claim 12, wherein the planet carrier is coupled to the mechanical ground by at least one bearing.

14. The robotic actuator of claim 12, wherein the motor, gearbox, and planet carrier are circumferentially surrounded by the mechanical ground.

15. The robotic actuator of claim 1, wherein the motor comprises:
a stator coupled to the mechanical ground and configured to generate a magnetic field; and
a rotor configured to generate the torque based on interaction between the rotor and the magnetic field.

16. The robotic actuator of claim 15, further comprising a sensor configured to detect commutation of the motor.

17. The robotic actuator of claim 16, wherein the sensor comprises an incremental rotary encoder.

18. The robotic actuator of claim 16, wherein the sensor comprises:
a ring magnet mounted to the motor, and
a read head coupled to the mechanical ground and configured to detect a magnetic field generated by the ring magnet.

19. The robotic actuator of claim 1, further comprising a sensor configured to detect an amount of output of the robotic actuator.

20. The robotic actuator of claim 19, wherein the sensor comprises:
a magnet coupled to a distal end of a shaft, wherein a proximal end of the shaft is coupled to the actuator output; and
a read head coupled to the mechanical ground and configured to detect a magnetic field generated by the magnet.

21. The robotic actuator of claim 20, wherein the read head is configured to generate a signal indicating angular displacement of the magnet relative to the mechanical ground.

22-56. (canceled)
